(19) United States
(12) Patent Application Publication
(10) Pub. No.: US 2017/0066096 A1
(43) Pub. Date: Mar. 9, 2017

(54) METHOD AND APPARATUS FOR DIRECT SETTING OF LUBRICANT OUTPUT AMOUNTS IN A MINIMUM QUANTITY LUBRICATION SYSTEM

(71) Applicant: UNIST, INC., GRAND RAPIDS, MI (US)

(72) Inventors: CHARLES W. BOELKINS, ADA, MI (US); MICHAEL TODD VEURINK, GRAND RAPIDS, MI (US); TIMOTHY JOHN BANGMA, ADA, MI (US); TIM WALKER, ROCKFORD, MI (US)

(21) Appl. No.: 15/255,178

(22) Filed: Sep. 2, 2016

Related U.S. Application Data
(60) Provisional application No. 62/213,891, filed on Sep. 3, 2015.

(51) Int. Cl. B23Q 11/10; B05B 12/08

(52) U.S. Cl. CPC B23Q 11/1046; B05B 12/085

(57) ABSTRACT

A system for particularly inputting and controlling a volume or pressure of a lubricating fluid or fluid-air mixture provided to a machining tool during minimum quantity lubrication machining operations. The system can further include a computer numeric control (CNC) machine and a minimum quantity lubrication system for providing lubrication to the CNC machine.

### CROSS-REFERENCE TO RELATED APPLICATIONS

This application claims priority to U.S. Provisional Patent Application No. 62/213,891, filed on Sep. 3, 2015, the entirety of which is incorporated herein by reference.

### BACKGROUND OF THE INVENTION

Minimum Quantity Lubrication (MQL) is a metal cutting lubrication process that is much more environmentally friendly than the traditional flood coolant process and is a process-sensitive approach to metal cutting. MQL uses a small amount of air and oil to lubricate the tool/metal interface during the cutting process instead of using massive amounts of liquid to quench the heat from the cutting process, based upon known requirements of the cutting tool.

The MQL process is sensitive to the amount of lubricant delivered during the metal cutting process. Too much lubricant leads to smoking due to burned lubricant, increased heat retention in the part, or a fogging of the lubricant, which is undesirable to operators, for air quality, or wasteful of the lubricant. Too little lubricant leads to cutting the metal while dry, which increases the heat generated, reduces the cutting tool life, and can cause thermal deformation of the workpiece. To achieve the desired amount of lubricant for the particular cutting operation, it is important to accurately know and control the amount of lubricant being applied. Otherwise, too little or too much lubricant can be applied.

Currently available systems for controlling the amount of lubricant provide for the supply of lubricant at multiple, predetermined amounts. The predetermined amounts are typically some value out of a preset lookup table or percentage of the lubricant output range of the lubricant system. The user can only select one of the values in the table and cannot input the desired amount. If any one of the predetermined amounts is not the desired amount for the given cutting operation, then too little or too much lubricant can be delivered.

### SUMMARY OF THE INVENTION

In one aspect, the disclosure relates to a minimum quantity lubrication (MQL) system for supplying lubricant to a computer numeric control (CNC) machine including a machining tool and a CNC controller operably coupled to the CNC machine for operating the CNC machine. The MQL system includes a MQL lubricant pump providing lubricant at a volumetric flow rate corresponding to a volumetric control signal. An MQL control interface includes a user-provided volumetric flow rate input in units of volume/time. An MQL controller operably couples to the MQL control interface to receive the volumetric flow rate input, convert the volumetric flow rate input to a volumetric control signal, and output the volumetric control signal to the MQL lubricant pump. The MQL lubricant pump supplies lubricant at the user-provided volumetric flow rate input based upon the volumetric control signal.

In another aspect, the disclosure relates to a method for providing a lubricant entrained in an air stream to a machining tool in a computer numeric control (CNC) machine by a minimum quantity lubrication (MQL) system. The method includes (1) receiving at a control interface operably coupled to the MQL system, a user-provided volumetric flow rate in units of volume/time, and (2) supplying by the MQL system, a lubricant entrained in the air stream to the CNC machine at the user-provided volumetric flow rate.

### BRIEF DESCRIPTION OF THE DRAWINGS

FIG. 1 is a schematic of a CNC machine using a MQL controller and MQL lubricant system.

FIG. 2 is a schematic of a machine tool using a MQL controller and lubricant system.

FIG. 3 is a schematic of a MQL lubricating system being controlled according to a user-defined volumetric flow rate for the lubricant.

FIG. 4 is a schematic view of the MQL lubricating system of FIG. 3 including an incorporated MQL controller with a programming interface.

FIG. 5 is an example of a user-defined operating parameter and value.

FIG. 6 is an example of a user interface for inputting the user-defined operating parameters and values of FIG. 5.

### DESCRIPTION OF EMBODIMENTS OF THE INVENTION

Embodiments of the invention provide for the minimum quantity lubrication (MQL) system to supply liquid at a user-defined volumetric flow rate, instead of predetermined volumetric flow rates. For prior MQL systems with variable supply rates, there are at least two factors why it was not possible to supply liquid at a user-defined volumetric flow rate. First, MQL applicators have been designed to communicate to the computer numeric control (CNC) machine via M-Codes, which are “miscellaneous” functions built into CNC machine controllers that operate on an on/off basis. The available number of un-used M-Codes limits the number of predetermined volumetric flow rates that can be implemented, which renders it practically impossible to have a user-defined, volumetric flow rate. The manufactures of the un-used M-Codes also charge to use the codes, which further restricts their use. The on/off nature of the M-Codes lends them to turning on/off the predetermined volumetric flow rate.

Second, the accuracy of the supply system prevents the practical implementation of a user-defined volumetric flow rate. Some prior systems use positive displacement pumps that are inherently accurate since they are volumetric, with errors in the range of 0.4% regardless of flow amount or fluid viscosity. However current implementations of the positive displacement pumps are discontinuous in their output and so do not give true continuous output at the specified rate, and in most cases are manually set so the output cannot be accurately known or set to a repeatable value. Other systems use continuous flow pumps with quick acting valves to limit the flow to a desired amount. However the quick acting valves have errors that approach the range of 5% to 20%, depending on fluid flow rates and the viscosity (which changes with temperature). The error rates of these systems render them practically incapable of accurately supplying lubricant at a user defined volumetric flow rate.

Embodiments of the invention combine suitably accurate pumps with a corresponding MQL control interface that permits the user to input a user-provided volumetric flow rate for the MQL system and the pump delivers the user-provided volumetric flow rate. The control interface can be either a user interface for the MQL system or a machine interface to the machine, such as a CNC machine, with the CNC machine controller outputting the control signal to the MQL system controller. A suitably accurate pump can be a continuous positive displacement pump, an example of which is provided in U.S. Pat. No. 6,012,903, which is incorporated by reference in its entirety. Other continuous positive displacement pumps use a reciprocating piston that supplies lubricant during both strokes of a given reciprocation. Additionally, the pump could be a continuous output pump or an intermittent positive displacement pump, in another non-limiting example. While there is no lubricant supplied during the instant between strokes, this delay is inconsequential and such a pump is considered a continuous positive displacement pump. It is also possible to have a series of non-continuous positive displacement pumps that are sequentially controlled such that their collective output is continuous.

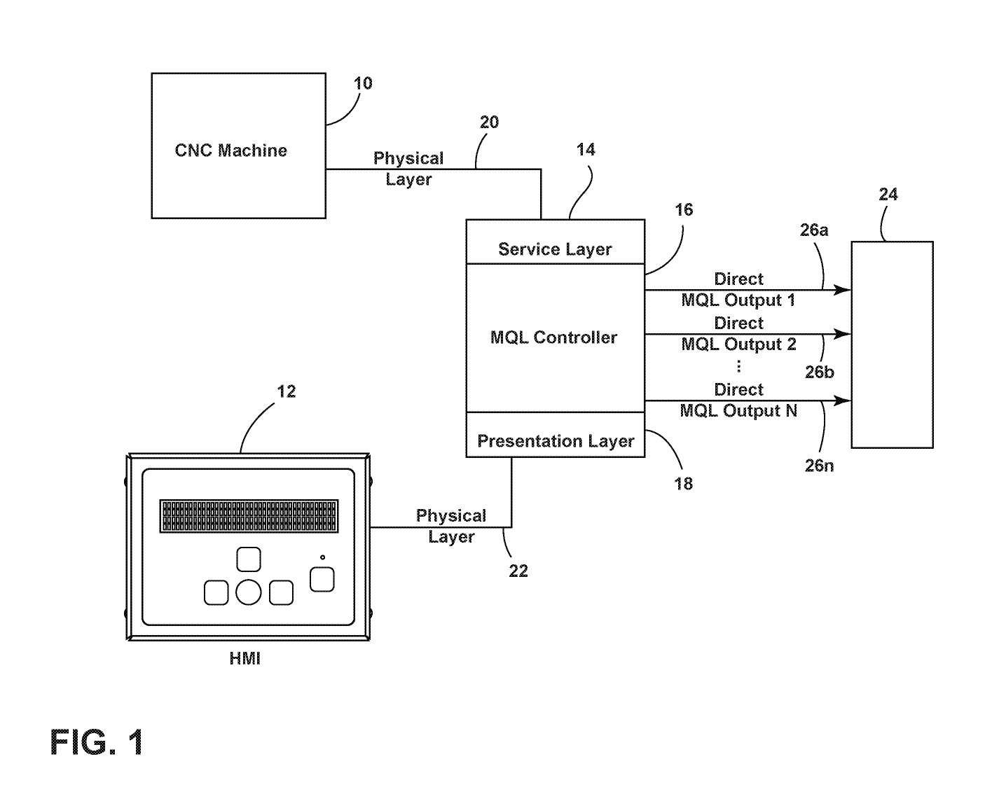

FIG. 1 schematically illustrates an implementation of a MQL system that is capable of supplying lubricant at a user-defined volumetric flow rate, which can be any unit of volume/time, such as ml/hr, drops/min, oz/min, ml/min, or oz/hr in non-limiting examples. The volumetric flow rate is user-provided without an intermediate reference to a lookup able, reference, or calculation, in non-limiting examples. Alternatively, there is no need for slight manual adjustment of the flow rates, as a particular volumetric flow rate can be specified. A CNC machine 10 is operably coupled to a MQL controller 16 through a service layer 14, and a Human Machine Interface (HMI) 12 is also operably coupled to the MQL controller 16 through a presentation layer 18. The service layer 14 can be a CNC communication channel communicatively coupling the CNC machine 10 to the MQL controller. The communication channel can be bi-directional. Additionally, the presentation layer 18 can communicate the volumetric flow rate to the MQL controller 16 from the HMI control interface 12.

The MQL controller 16 may be operably coupled to the CNC machine 10 and the HMI 12 simultaneously or the coupling may be through one of these individually. The service layer 14 is in data communication with the CNC machine 10 over the physical layer 20. Similarly, the presentation layer 18 is in data communication with the HMI 12 over a second physical layer 22. The physical layers 20 and 22 can be any suitable form of data communication, or data communications channel, such as: Wi-Fi, Ethernet, RS-232, etc. They need not be the same form of data communication. Any suitable communications protocol may be used. The communications can be bi-directional.

The HMI 12 can be the exemplary control interface, with suitable inputs, such as switches, knobs, alpha and/or numeric keypad to enable the entry of the user defined volumetric flow rate. Alternatively, as a machine control interface, the HMI 12 receives the provided volumetric flow rate from the CNC machine 10. While the HMI 12 is shown physically separate from the CNC machine 10 and the MQL controller 16, the HMI 12 can be a stand-alone HMI as illustrated or it can be integrated with either one of the CNC machine 10 or the MQL controller 16. If integrated with the CNC machine 10, the HMI 12 could communicate with the MQL Controller 16 over the physical layer 20, instead of the second physical layer 22. If the HMI 12 is integrated with the MQL Controller 16, the second physical layer 22 can be optional.

The service layer 14 performs the data communication between the CNC machine 10 and the MQL controller 16. The service layer 14 receives/sends inputs/outputs between the CNC machine 10 and the MQL controller 16, including making any data and protocol conversions necessary to properly communicate between the CNC machine 10 and the MQL controller 16.

Similarly, the presentation layer 18 performs the data communication between the HMI 12 and the MQL controller 16. The presentation layer 18 receives/sends inputs/outputs between the HMI 12 and the MQL controller 16, including making any data and protocol conversions necessary to properly communicate between the HMI 12 and the MQL controller 16.

The MQL controller 16 uses the data sent/received from the CNC machine and the HMI 12 to control the operation of the MQL lubrication system 24 via MQL outputs 26a, 26b . . . 26n. Each of the MQL outputs 26a can control a corresponding pump for the MQL lubrication system 24. The MQL outputs 26a can be a volumetric control signal provided from the MQL controller 16 to the lubrication system at a CNC output. The volumetric control signal can be tailored to a particular corresponding pump, such as the continuous output pump or an intermittent positive displacement pump, for example.

The MQL controller 16 operably couples to the MQL control interface, such as the HMI 12, to receive the volumetric flow rate input, convert the volumetric flow rate input to the volumetric control signal, and output the volumetric control signal to the pump. The control signal can be, for example, data packets communicated from the controller 16 representative of the volumetric flow rate. As such, the pump can supply lubricant at the volumetric flow rate based upon the volumetric control signal.

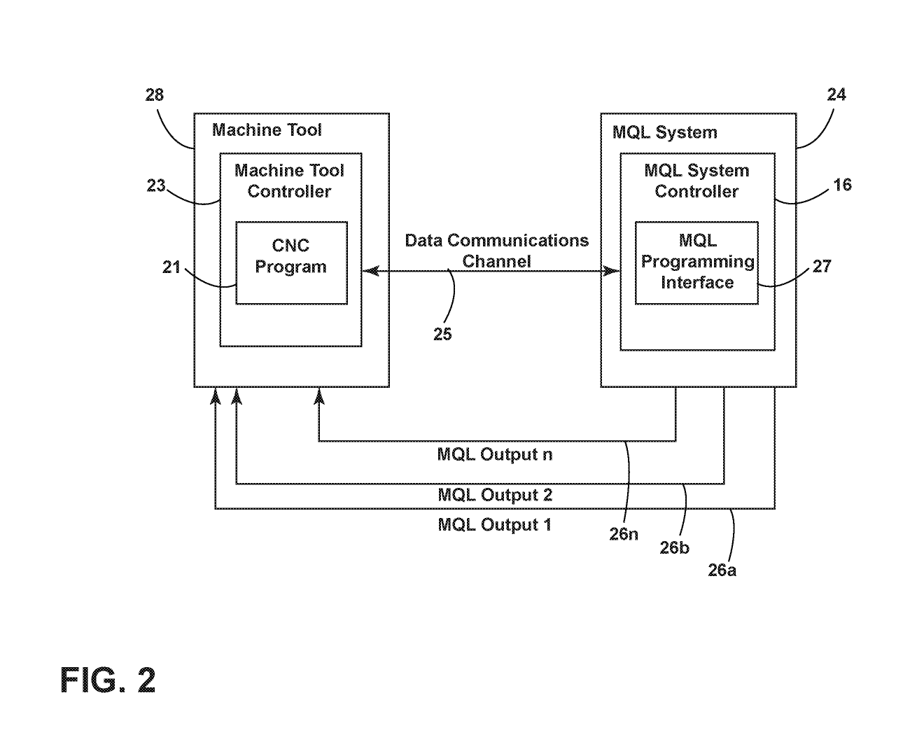

FIG. 2 schematically illustrates another implementation of a MQL system that allows a CNC program 21 to digitally specify and control the actual volumetric flow rate for the MQL System 24 without requiring an intermediary lookup, reference, or calculation. A machine tool controller 23 operably couples to the MQL controller 16 and provides the required information through a data communication channel 25, such as the physical layers 20, 22 of FIG. 1. A MQL programming interface 27 is specified for the CNC Program 21 and implemented in the MQL Controller 16 to define which MQL output 26a . . . 26n is to be controlled. Such control can determine the desired fluid output rate and, optionally, the desired airflow.

The data communications or physical layer 20 can be provided using RS-232 serial communications in one non-limiting example, as most machine tools 28 have an RS232 port that is also used for transferring CNC programs 21 between separate machines. In addition, most machine tool controllers 23 also natively support accessing the RS-232 port from within the CNC program 21. This greatly simplifies accessing the MQL controller programming interface 27. Although this system uses RS-232 serial communications, the data communications 25 can be done using any suitable physical transport and data communications layer, such as wired or wireless Ethernet, USB, ProfiNet, or ProfiBus in non-limiting examples.

The minimum information that can be passed from the CNC program 21 to the MQL programming interface 27 can be a volumetric flow rate. However many MQL systems 24 have multiple MQL outputs 26a, 26b . . . 26n and can require adding a specification for which output 26a, 26b . . . 26n is specified with which fluid rate being set. And since MQL outputs 26a, 26b . . . 26n combine fluid and air, it is common to specify the flow rate for the air as well as for the fluid. The programming interface 27 can take the output identifier, the actual flow rate, and a percentage of the input airflow, such as the air flow rate, in a single function call from the machine tool controller 23.

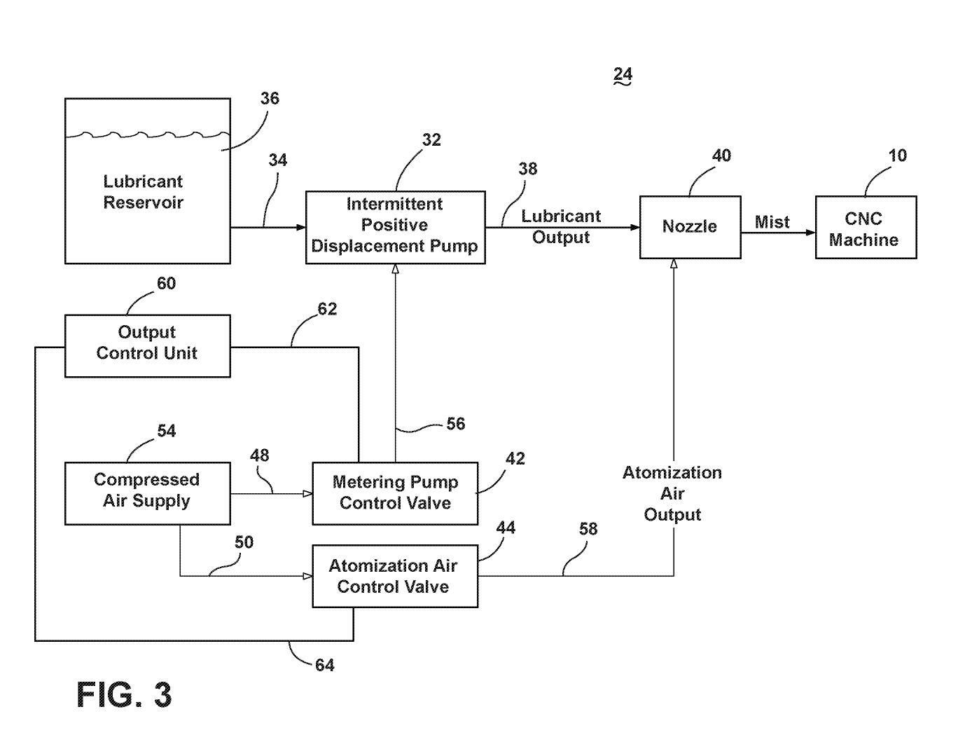

FIG. 3 illustrates an exemplary MQL lubrication system 24 having a pump 32, such as an intermittent positive displacement pump in one non-limiting example, having an input line 34 fluidly coupled to a lubricant reservoir 36 and an output line 38 fluidly coupled to a nozzle 40. In the configuration, the pump 32 draws lubricant from the reservoir 36 through the input line 34 and supplies the lubricant through the output line 38 to the nozzle 40.

The MQL lubrication system 24 further includes a series of control valves including metering pump control valve 42 and atomization air control valve 44, each having a corresponding input line 62 and 64 which is electrically coupled to an output control unit 60. The valves 42, 44 can operate as output control units operably coupled to the pump and the compressed air supply 54 to supply the lubricant in a stream of air at the user-provided volumetric flow rate. The output control unit 60 contains the service layer 14 and the presentation layer 18 and converts the inputs from the CNC machine 10 or the HMI 12 to the control signals needed to for the metering control valve 42 and atomization air control valve 44. The atomization air control valve 44 and metering pump control valve 42 are also fluidly coupled through corresponding input lines 48 and 50, which are fluidly coupled to a compressed air supply 54. The compressed air supply 54 can provide the lubricant to the machining tool 10 at the volumetric flow rate as an aerosol. The metering pump control valve 42 has an output line 56 fluidly coupled to the pump 32, with the compressed air being used to control the actuation of the pump 32 according to the MQL Output 26a. The atomized air control valve 44 has an output line 58 providing atomized air to the nozzle 40. That is the ON/OFF supply of air through the metering pump control valve 42 controls the ON/OFF supply of lubricant from the pump 32. Examples of the operation and control of positive displacement pumps can generally be found in the following US patents, which are all incorporated by reference in their entirety: U.S. Pat. No. 3,888,420, U.S. Pat. No. 5,524,729, and U.S. Pat. No. 6,567,710.

While only one pump 32 is illustrated, as many pumps 32 as desired can be controlled, with each of the MQL Outputs 26a, 26b . . . 26n being used to control a different pump 32.

In one possible implementation, HMI 12 is a digital interface and the service layer 14 and presentation layer 18 are logical layers, such as software. The physical layers 20, 22 are implemented as RS-232 serial communications, which are commonly found on CNC machines. The service layer 14 is accomplished through a pre-defined interface providing for the values set for operating parameters, such as the selection of the parameter to set and the setting of the value for the parameter. An example of which would be the lubricant and the rate of the lubricant. It is through the service layer 14 that machine tool programs or other digital or electrical controllers set the desired values. The presentation layer 18 is a logical layer that establishes communication through the HMI 12 and provides for the user to set the values for the operating parameters, which includes the lubricant volumetric flow rate for the MQL System.

In a specific example, if 10.5 ml/hr is the desired volumetric flow rate for the MQL lubricant, then the amount of 10.5 ml/hr is directly specified to the MQL controller 16. The user will select the lubricant flow rate as the operating parameter on the HMI 12. Once selected, the user then selects the value for the volumetric flow rate. The selection of the parameter and the corresponding value is communicated through the presentation layer 18 to the MQL controller 16, which then generates a corresponding control signal through the output control unit 60, and sends it to the metering pump control valve 42, which controls the pump 32 to supply the lubricant at the user-selected volumetric flow rate through MQL output 26a.

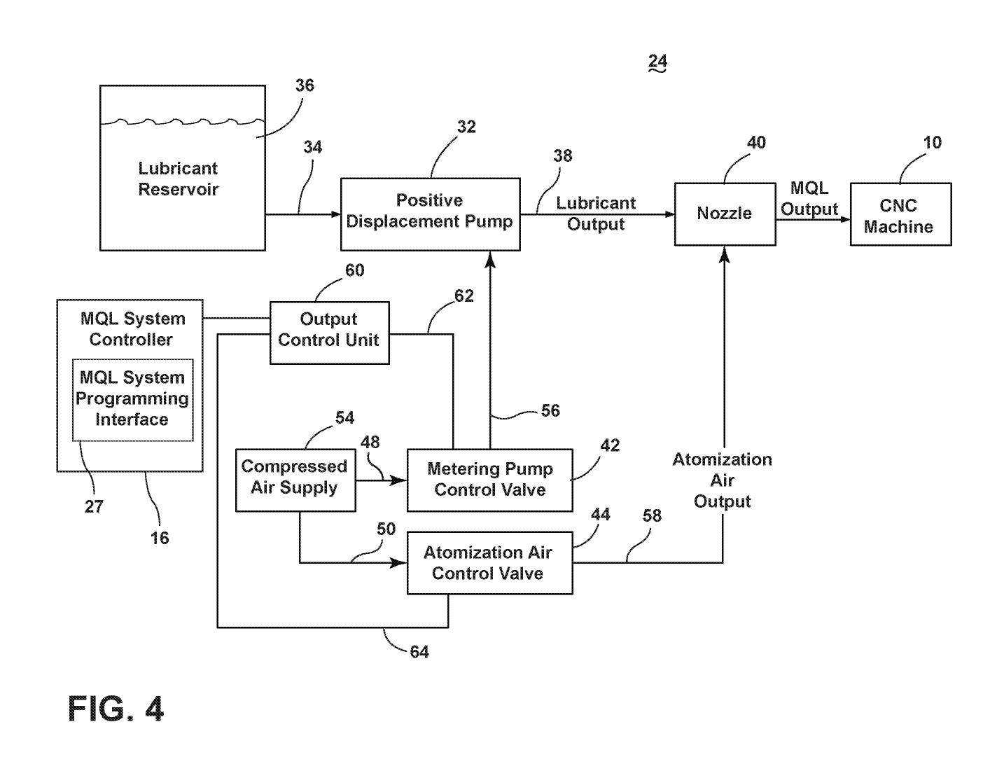

FIG. 4 illustrates another exemplary MQL system 24 interconnected to the MQL system controller 16 with programming interface 27. The MQL system 24 of FIG. 4 can be substantially similar to that of FIG. 3. As such, similar numerals will be used to identify similar elements. It should be appreciated that the MQL system controller 16 can communicatively couple to the output control unit 60, for providing a signal to the output control unit 60. Such a signal can be representative of parameters input at the MQL programming interface 27. At the programming interface 27, particular measurements can be specified, such as output identifier, the actual flow rate, and a percentage of the input airflow, as well as particular flow rates, pressures, or other measurements of both the fluid and the air.

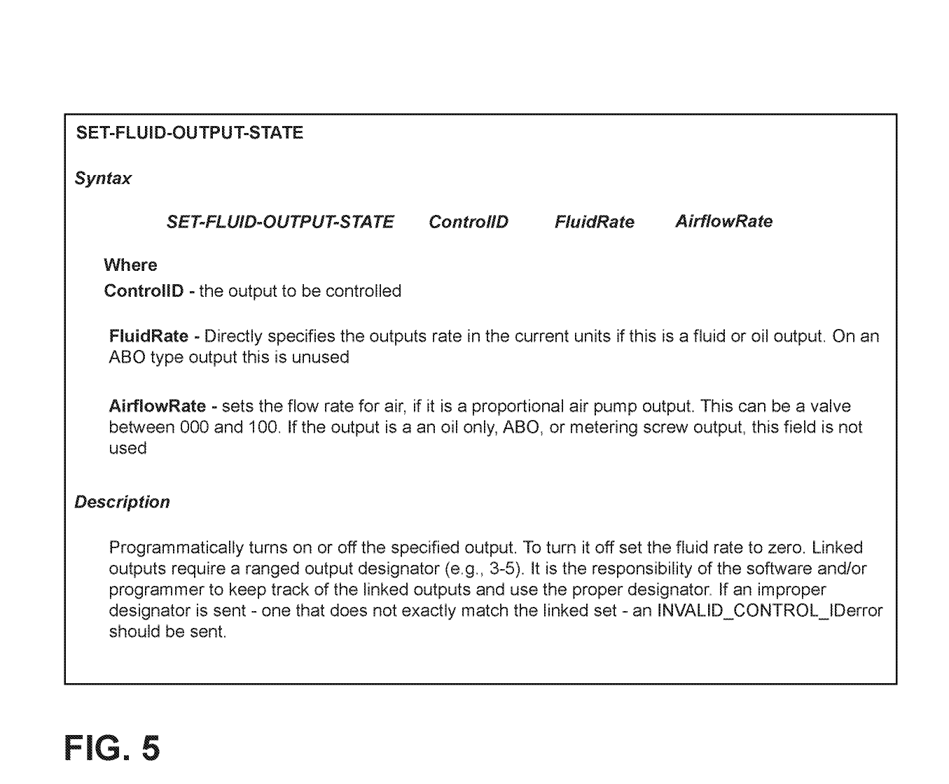

FIG. 5 illustrates one example of a user-defined operating parameter and corresponding value, which can be set. The operating parameter corresponds to a ControlID, which identifies the hardware to be controlled. In this case the ControlID corresponds to a control signal for one of the pumps 32. The FluidRate value provides for the user to input the volumetric flow rate for the selected ControlID. There is also a corresponding AirflowRate value that can be entered to control the rate of air that is mixed with the fluid to form the lubricating mist.

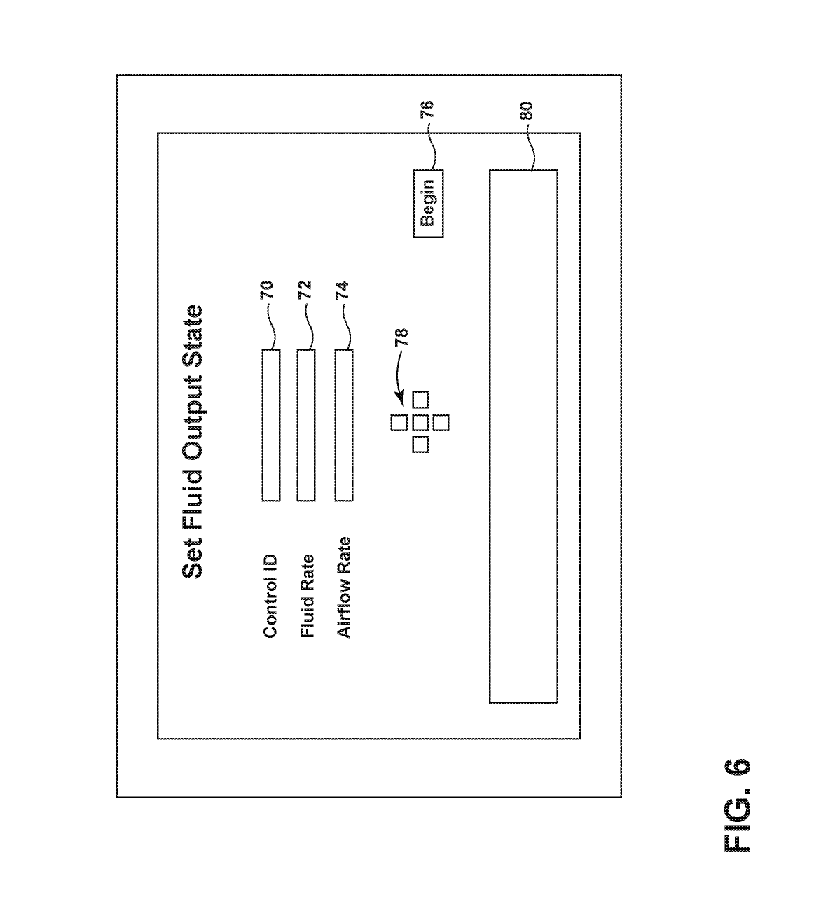

FIG. 6 illustrates an exemplary user interface 68, which can be used for the MQL programming interface 27, of FIG. 4, for inputting the ControlID 70, the FluidRate 72, or the AirflowRate 74 of FIG. 5. For example, the ControlID 70 can be representative of a particular tool or cut in order to record within the CNC machine the proper values for future reference. Additionally, the FluidRate 72 and the AirflowRate 74 can be particularly input to produce a particular fluid-to-air ratio to the tool. Alternatively, it is contemplated that a fluid-to-air ratio could be particularly input at the user interface 68, similar to the FluidRate 72 or the AirflowRate 74.

Additionally, the user interface 68 can include a begin button 76 for initiating provision of the fluid and airflow mixture to a tool and a control panel 78 for navigating the user interface 68. Additionally, a notes box 80 can be used for recording additional information or displaying recorded information from prior uses.

It should be appreciated that the user interface 68 as shown is exemplary, and any user interface accepting any input can be used to provide a signal to the controller of the MQL lubrication system, such as the output control unit 60 of FIG. 3 or 4.

A method for providing a lubricant entrained in an air stream to a machining tool in a computer numeric control (CNC) machine by a minimum quantity lubrication (MQL) system can include: (1) receiving, at a control interface operably coupled to the MQL system, a user provided volumetric flow rate in units of volume/time, and (2) supplying, by the MQL system, a lubricant entrained in the air stream to the CNC machine at the user-provided volumetric flow rate. The user-provided volumetric flow rate can be converted to a control signal representative of the volumetric flow rate to be provided by the pump. Such a conversion can be accomplished by the MQL controller 16 or FIG. 1, for example.

The supplying of the lubricant at the volumetric flow rate can be accomplished without the requirement of an intermediate reference to a lookup table, reference, calculation, or requiring a user to manually adjust the flow rate of the lubricant in attempt to properly lubricate the tool. The control interface can be a control interface for the MQL system, such as an HMI 12 (FIG. 1), or a machine interface with the CNC machine 10 (FIG. 1).

The receiving of step (1) of the method can further comprise receiving multiple user-provided volumetric flow rates. Such multiple flow rates can be provided in sequence, such as for a variable flow rate over time or differing flow rates. Additionally, the multiple flow rates, or single flow rate can be stored in a memory for later use.

It should be appreciated that the system permits control of a volume and flow rate of air and lubricating fluid being provided to a spindle or tool for use with MQL machining. The particular control system can particularly specify a flow rate particular to the individual tool, rather than attempting to approximate the appropriate lubrication based upon old M-Codes, which would otherwise lead to too much lubrication or too little lubrication. As such, tool life is extended and reduced lubricant usage.

This written description uses examples to disclose the invention, including the best mode, and to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A minimum quantity lubrication (MQL) system for supplying lubricant to a computer numeric control (CNC) machine including a machining tool and a CNC controller operably coupled to the CNC machine for operating the CNC machine, the MQL system comprising:
an MQL lubricant pump providing lubricant at a volumetric flow rate corresponding to a volumetric control signal;
an MQL control interface having a user-provided volumetric flow rate input in units of volume/time;
an MQL controller operably coupled to the MQL control interface to receive the volumetric flow rate input, convert the volumetric flow rate input to a volumetric control signal, and output the volumetric control signal, to the MQL lubricant pump;
wherein the MQL lubricant pump supplies lubricant at the user-provided volumetric flow rate input based upon the volumetric control signal.

2. The MQL system of claim 1, wherein the MQL control interface has a user interface for entering the user-provided volumetric flow rate input.

3. The MQL system of claim 2, wherein the user-provided volumetric flow rate input is in units ml/hr, drops/min, oz/hr, oz/min, ml/min.

4. The MQL system of claim 1, wherein the user-provided volumetric flow rate input is without a reference to a lookup table, reference, manual adjustment, or calculation.

5. The MQL system of claim 1, wherein the MQL controller has a CNC communication channel and the volumetric flow rate input is provided to the CNC controller through the CNC communication channel.

6. The MQL system of claim 5 wherein communication channel is bi-directional.

7. The MQL system of claim 1 wherein the lubricant pump is a positive displacement pump.

8. The MQL system of claim 7 wherein the positive displacement pump is one of a continuous output pump or an intermittent positive displacement pump.

9. The MQL system of claim 8 wherein the volumetric control signal is tailored to specific to the pump.

10. The MQL system of claim 1 further comprising a compressed air supply to provide the lubricant as an aerosol to the machining tool.

11. The MQL system of claim 10 further comprising an output control unit operably coupled to the pump and the compressed air supply to supply the lubricant in a stream of air at the user-provided volumetric flow rate input.

12. A method for providing a lubricant entrained in an air stream to a machining tool in a computer numeric control (CNC) machine by a minimum quantity lubrication (MQL) system, the method comprising:
receiving at a control interface operably coupled to the MQL system a user-provided volumetric flow rate in units of volume/time; and
supplying by the MQL system a lubricant entrained in the air stream to the CNC machine at the user-provided volumetric flow rate.

13. The method of claim 12 wherein the user-provided volumetric flow rate is converted to a control signal being representative of the volumetric flow rate as provided by the pump.

14. The method of claim 13 wherein the control signal is tailored to specific to the pump.

15. The method of claim 3 wherein the supplying is accomplished without the use of a lookup table, reference, manual adjustment, or algorithm.

16. The method of claim 12 wherein the control interface comprises at least one of a control interface for the MQL system, HMI, or CNC machine.

17. The method of claim 12 wherein the receiving comprises receiving multiple user-provided volumetric flow rates.

18. The method of claim 17 wherein the MQL system supplies the lubricant in sequence according to the multiple user-provided volumetric flow rates.

19. The method of claim 18 wherein the multiple user-provided volumetric flow rates are stored in a memory of the MQL system.
